(19) United States
(12) Patent Application Publication
(10) Pub. No.: US 2016/0065360 A1
(43) Pub. Date: Mar. 3, 2016

(54) RADIO COMMUNICATION APPARATUS

(71) Applicant: KABUSHIKI KAISHA TOSHIBA, Tokyo (JP)

(72) Inventor: Yoshiaki YOSHIHARA, Yokohama Kanagawa (JP)

(21) Appl. No.: 14/634,869

(22) Filed: Mar. 1, 2015

(30) Foreign Application Priority Data
Aug. 27, 2014 (JP) 2014-172765

(51) Int. Cl. H04L 7/033; H04L 27/152; H04L 25/40

(52) U.S. Cl. CPC H04L 7/033; H04L 25/40; H04L 27/152

(57) ABSTRACT

A radio communication apparatus includes an adjustment unit, a transmitting unit, a correction unit, and a control unit. The adjustment unit adjusts a first frequency of a clock signal to generate a second clock signal having a second frequency using an adjustment value. The transmitting unit transmits the second clock signal having the second frequency. The correction unit corrects the second frequency of the second clock signal that is transmitted by the transmitting unit, which results in a third frequency, using a correction value. The control unit sets the adjustment value according to a receive frequency of a receive signal, obtains the correction value from the adjustment value, and sets the correction value.

### CROSS-REFERENCE TO RELATED APPLICATION

This application is based upon and claims the benefit of priority from Japanese Patent Application No. 2014-172765, filed Aug. 27, 2014, the entire contents of which are incorporated herein by reference.

### FIELD

Exemplary embodiments described herein relate generally to a radio communication apparatus.

### BACKGROUND

A radio communication apparatus operates based on various clock signals. The clock signal is in the form of a square wave and, for this reason, includes multiple harmonic components. The harmonic components propagate to an antenna terminal of a receive unit into which a receive signal is sent. Therefore, when a high-order harmonic frequency of the clock signal overlaps a frequency of the receive signal, a loss in reception sensitivity occurs.

### DESCRIPTION OF THE DRAWINGS

FIG. 1 is a block diagram illustrating a schematic configuration of a radio communication apparatus according to an embodiment.

FIGS. 2A and 2B are diagrams illustrating harmonic signal strength and a harmonic receive frequency in the radio communication apparatus according to the embodiment.

FIG. 3 is a diagram illustrating configurations of components between a reference oscillation circuit and a BBPLL within the radio communication apparatus according to the embodiment.

FIG. 4 is a diagram illustrating harmonic signal strength and a harmonic receive frequency in configurations illustrated in FIG. 3.

FIG. 5 is a circuit diagram illustrating a configuration of an adjustment unit within the radio communication apparatus according to the embodiment.

FIG. 6 is a circuit diagram illustrating a configuration of a correction unit within the radio communication apparatus according to the embodiment.

FIG. 7 is a diagram illustrating one example of frequencies of various clock signals according to the embodiment.

FIGS. 8A and 8B are diagrams illustrating one example of frequencies of adjustment clock signals according to the embodiment.

FIG. 9 is a diagram illustrating a frequency and a harmonic frequency of the adjustment clock signal in a band of a receive frequency for Bluetooth.

### DETAILED DESCRIPTION

Embodiments provide a radio communication apparatus capable of reducing loss of reception sensitivity due to a harmonic occurring in a transmission path for a clock signal.

In general, according to one embodiment, a radio communication apparatus includes: an adjustment unit that adjusts a first frequency of a first clock signal to generate a second clock signal having a second frequency, using an adjustment value; a transmitting unit that transmits the second clock signal; a correction unit that corrects the second frequency of the second clock signal that is transmitted by the transmitting unit, which results in a third frequency, using a correction value; and a control unit that sets the adjustment value according to a receive frequency of a receive signal, obtains the correction value from the adjustment value, and sets the correction value.

Embodiments are described below referring to the drawings. Alternatively, in the following descriptions, structural elements having the same function and configuration are given like reference numerals, and redundant descriptions thereof are provided whenever necessary.

First, a schematic configuration of a radio communication apparatus according to an embodiment is described.

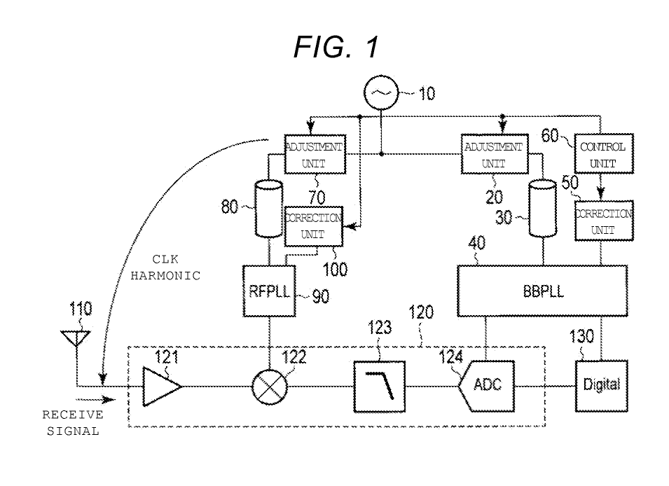

FIG. 1 is a block diagram illustrating the schematic configuration of the radio communication apparatus according to the embodiment. As illustrated in FIG. 1, the radio communication apparatus includes a reference oscillation circuit 10, an adjustment unit 20, a clock transmitting unit 30, a base band phase locked loop (BBPLL) 40, a correction unit 50, a control unit 60, an adjustment unit 70, a clock transmitting unit 80, radio frequency phase locked loop (RFPLL) 90, a correction unit 100, an antenna 110, a receiving unit 120, and a digital circuit 130.

The reference oscillation circuit 10 generates a reference clock signal CLK in the form of a square wave. The clock signal CLK has a frequency Fosc (first frequency) and contains multiple harmonics. The reference oscillation circuit 10, for example, is configured from a crystal oscillator or the like.

Each of the adjustment units 20 and 70 adjusts the frequency Fosc of the clock signal CLK generated by the reference oscillation circuit 10 using an adjustment value, based on a control signal CL1 (or an instruction) from the control unit 60, and outputs an adjustment clock signal CLKa that has a frequency Fclk (second frequency).

Each of the clock transmitting units 30 and 80 transmits the adjustment clock signal CLKa that is supplied from the adjustment units 20 and 70, respectively.

Each of the correction units 50 and 100 corrects a frequency control code FCW using a correction value, based on a control signal CL2 (or an instruction) from the control unit 60, and outputs a corrected frequency control code FCWc.

In operation, the BBPLL 40 is synchronized to the adjustment clock signal CLKa that is transmitted by the clock transmitting unit 30. Specifically, the BBPLL 40 generates the clock signal CLKb of a frequency FPLL (third frequency), based on the adjustment clock signal CLKa and the frequency control code FCW or the corrected frequency control code FCWc.

In operation, the RFPLL 90 is synchronized to the adjustment clock signal CLKa that is transmitted by the clock transmitting unit 80. Specifically, the RFPLL 90 generates a local signal CLKr at a harmonic frequency Frf, based on the adjustment clock signal CLKa and the frequency control code FCW or the corrected frequency control code FCWc.

The correction unit 50 and the BBPLL 40 are collectively also called a correction unit; and the correction unit 100 and the RFPLL 90 are collectively also called a correction unit.

The receiving unit 120 receives a received signal SRX that is a radio signal, through the antenna 110. Specifically, the receiving unit 120 receives the received signal SRX at a frequency corresponding to the frequency Frf of the local signal CLKr. According to the present embodiment, the receiving unit 120 receives the received signal SRX whose central frequency is the frequency Frf of the local signal CLKr. The central frequency is referred to as a received frequency Frx of the received signal SRX. The received signal SRX has a predetermined bandwidth in accordance with radio communication standards.

The receiving unit 120 has an amplifier 121, a mixer 122, a filter 123, and an analog-to-digital converter (hereinafter referred to as an A/D converter) 124.

The amplifier 121 amplifies the received signal SRX. The mixer 122 frequency-converts the received signal SRX that is amplified by the amplifier 121, using the local signal CLKr, and outputs a result of the frequency conversion as a lower frequency signal than the received signal SRX.

The filter 123 band-limits the low-frequency signal that is output from the mixer 122.

The A/D converter 124 converts the low-frequency analog signal that is band-limited by the filter 123 into a digital signal. For operation, the A/D converter 124 is synchronized with the clock signal CLKb.

The digital circuit 130 signal-processes the digital signal supplied from the A/D converter 124 and thus obtains received data. In operation, the digital circuit 130 is synchronized with the clock signal CLKb.

The control unit 60 sets an adjustment value for each of the adjustment units 20 and 70, according to the received frequency Frx of the received signal SRX that is received by the receiving unit 120. The control unit 60 obtains a correction value from the adjustment value, and sets a correction value for each of the correction units 50 and 100.

Specifically, if a harmonic frequency of the clock signal CLK (frequency Fosc) overlaps the received frequency Frx of the received signal SRX, the control unit 60 instructs the adjustment units 20 and 70 to adjust the frequency Fosc to the frequency Fclk using the adjustment value. Accordingly, a harmonic frequency of the clock signal CLKa (frequency Fclk) that is transmitted by the clock transmitting units 30 and 80 does not overlap the received frequency Frx.

Furthermore, if the frequency Fosc of the clock signal CLK is adjusted using an adjustment value, the control unit 60 obtains a correction value based on the adjustment value, and corrects the frequency Fclk, which results in the frequency FPLL or the frequency Frf, using the correction value. Adjustments by the adjustment units 20 and 70, and corrections by the correction units 50 and 100 are described in detail below.

Alternatively, if a the harmonic frequency of the clock signal CLK does not overlap the received frequency Frx of the received signal SRX, the control unit 60 outputs the clock signal CLK to each of the clock transmitting units 30 and 80 without performing the adjustments by the adjustment units 20 and 70. In this case, of course, the corrections by the correction units 50 and 100 are not performed.

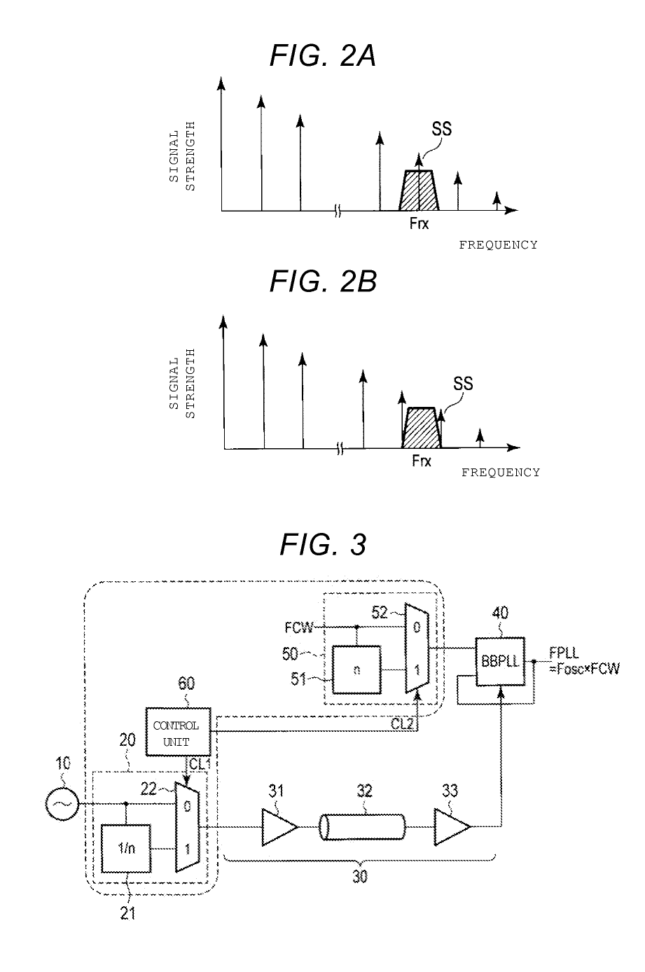

Operation of the radio communication apparatus according to the embodiment is described with referring to FIGS. 1 to 2B. FIGS. 2A and 2B are diagrams illustrating harmonic signal strength and harmonic receive frequency in the radio communication apparatus according to the embodiment.

Before describing the operation, frequencies of various signals described above are briefly defined as follows. The receive frequency of the received signal SRX that is received by the antenna 110 and the receiving unit 120 is defined as Frx. A frequency of the clock signal CLK that is generated by the reference oscillation circuit 10 is defined as Fosc. A frequency of an adjustment clock signal CLKa (clock signal that is input into the BBPLL 40 and the RFPLL 90), which results from the adjustment units 20 and 70 adjusting the frequency Fosc of the clock signal CLK, is defined as Fclk. Moreover, frequencies of the clock signals, which result from the BBPLL 40 and the RFPLL 90 correcting the frequency Fclk of the adjustment clock signal CLKa, are defined as FPLL and Frf, respectively.

The operation of the radio communication apparatus according to the embodiment during reception is described below.

The signal SRX received by the antenna 110 is input into the receiving unit 120. The signal SRX is amplified by the amplifier 121 and is input into the mixer 122. The signal SRX being input into the mixer 122 is frequency-converted (in this embodiment, down-converted) with the local signal CLKr, and is output as a lower-frequency signal than the signal SRX.

The receive signal, being input into the filter 123, is band-limited and sent into the A/D converter 124. The receive signal, being input into the A/D converter 124, is converted from an analog signal to a digital signal. The receive signal that is converted into the digital signal by the A/D converter 124 is then signal-processed by the digital circuit 130.

For example, as illustrated in FIG. 2A, a frequency band that has greater signal strength SS from a harmonic of the clock signal is present for every high-order frequency of the clock signal. If these frequencies, each of which has greater signal strength SS, overlap the received frequency Frx of the received signal SRX, then when the harmonic propagates to the antenna 110, reception sensitivity significantly deteriorates.

According to the present embodiment, the harmonic frequency of the clock signal CLK overlaps the received frequency Frx of the received signal SRX, the frequency Fosc of the clock signal CLK is adjusted, and thus, as illustrated in FIG. 2B, the harmonic frequency of the frequency Fclk does not overlap the received frequency Frx. Accordingly, the degradation of the reception sensitivity in the receiving unit 120 due to a harmonic of the clock signal CLK is suppressed.

When the frequency Fosc of the clock signal CLK is adjusted, and the frequency Fclk is input into the BBPLL 40 and the RFPLL 90, frequencies of the clock signals that are output from the BBPLL 40 and the RFPLL 90 change. When the frequencies of the clock signals that are output from the BBPLL 40 and the RFPLL 90 change, this upsets operation of a circuit that operates with the clock signals serving as reference clocks, for example, the A/D converter 124, the digital circuit 130, or the mixer 122.

According to the present embodiment, the frequency control code FCW is corrected based on the adjustment value that is used when the frequency Fosc is adjusted to the frequency Fclk, and thus the frequencies of the clock signals that are output from the BBPLL 40 and the RFPLL 90 do not change. Accordingly, the operation of the circuit that operates with the clock signals being output from the BBPLL 40 and the RFPLL 90 serving as the reference clock, for example, such as the A/D converter 124, the digital circuit 130, or the mixer 122, is not influenced.

Next, configuration and operation of each of the adjustment unit 20, the control unit 60, the correction unit 50, and the clock transmitting unit 30 within the radio communication apparatus according to the embodiment are described in detail.

FIG. 3 is a diagram illustrating the configurations of the adjustment unit 20, the control unit 60, the correction unit 50, and the clock transmitting unit 30 that are disposed between the reference oscillation circuit 10 and the BBPLL 40 in FIG. 1.

The adjustment unit 20 includes a frequency conversion circuit 21 and a selection circuit 22. The frequency conversion circuit 21 converts the frequency Fosc of the reference clock signal CLK that is output from the reference oscillation circuit 10, and outputs a result of the conversion to an input channel 1 within the selection circuit 22. Specifically, the frequency conversion circuit 21 multiplies the frequency Fosc of the clock signal CLK by (1/n) and thus converts the frequency Fosc into the frequency Fclk. The number n is set in such a manner that the harmonic frequency of the clock signal CLKa (frequency Fclk) does not overlap the received frequency Frx of the received signal SRX. At this point, the adjustment value that used by the adjustment unit 20 is 1/n, and 1/n is set to a small numerical value that is about 1. In other words, the adjustment unit 20 adjusts the frequency Fclk by multiplying the frequency Fosc by a small numerical value that is about 1.

The clock signal CLKa (frequency Fclk) is input into the input channel 1 within the selection circuit 22, and the clock signal CLK (frequency Fosc) is input into an input channel 0. The selection circuit 22 selects either of the reference clock signal CLK or the adjustment clock signal CLKa that are input into the input channels 0 and 1, respectively, according to the control signal CL1 (or instruction) from the control unit 60, and outputs the selected signal to the clock transmitting unit 30.

The clock transmitting unit 30 includes an amplifier 31, a transmission path 32, and an amplifier 33, and transmits the reference clock signal CLK or the adjustment clock signal CLKa.

The correction unit 50 includes a code conversion circuit 51 and a selection circuit 52. The code conversion circuit 51 corrects the frequency control code FCW, and outputs the corrected frequency control code FCWc to the input channel 1 within the selection circuit 52. Specifically, the code conversion circuit 51 multiplies the frequency control code FCW by n, and thus converts a result of the multiplication into the frequency control code FCWc. Since the frequency Fosc is multiplied by (1/n) in the frequency conversion circuit 21, the frequency control code FCW is multiplied by n in the code conversion circuit 51.

The frequency control code FCWc is input into the input channel 1 within the selection circuit 52, and the frequency control code FCW is input into the input channel 0 within the selection circuit 52. The selection circuit 52 selects either of the frequency control code FCW or the corrected frequency control code FCWc that are input into the input channels 0 and 1, respectively, according to the control signal CL2 from the control unit 60, and outputs the selected code to the BBPLL 40.

The BBPLL 40 corrects the frequency Fclk of the adjustment clock signal CLKa based on the frequency control code FCW or the corrected frequency control code FCWc that is selected by the selection circuit 52, and outputs the clock signal CLKb (frequency FPLL). Thereafter, the clock signal CLKb is used as an operational clock signal in the A/D converter 124 and the digital circuit 130.

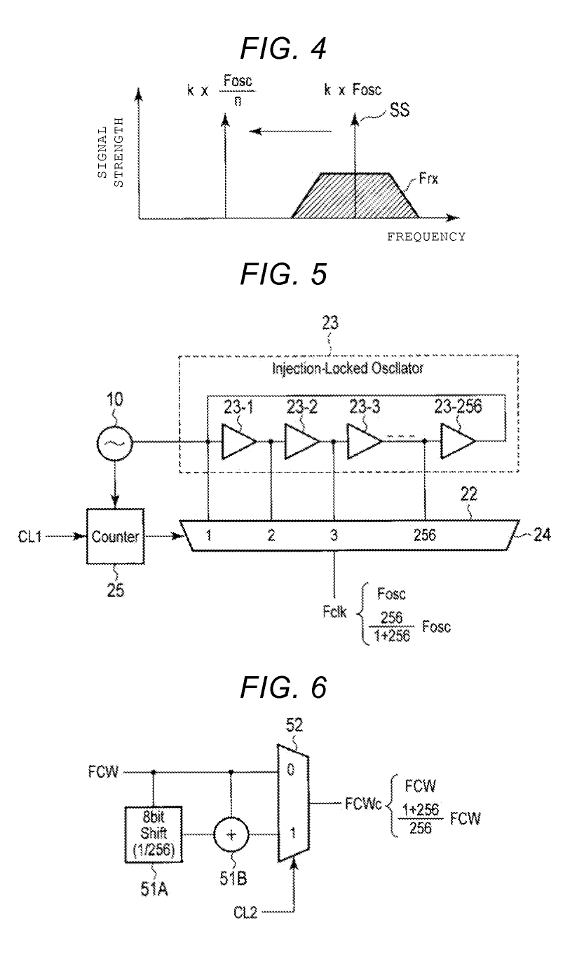

FIG. 4 illustrates the harmonic signal strength and the harmonic receive frequency in the configurations illustrated in FIG. 3. If, as illustrated in FIG. 4, the received frequency Frx of the received signal SRX and the harmonic frequency of the clock signal CLK (k×Fosc) overlap each other, it is difficult to correctly receive the receive signal.

When the harmonic frequency (k×Fosc) of the clock signal CLK overlaps the received frequency Frx of the received signal SRX, the control unit 60 selects the input channel 1 within the selection circuit 22 according to the control signal CL1. Accordingly, the selection circuit 22 outputs the clock signal CLKa (frequency Fclk), which is input into the input channel 1, to the clock transmitting unit 30. That is, if the harmonic frequency (k×Fosc) and the received frequency Frx overlap each other, the control unit 60 selects the adjustment clock signal CLKa that results from the frequency Fosc of the clock signal CLK being multiplied by (1/n), and outputs the selected adjusted clock signal CLKa to the clock transmitting unit 30.

In this manner, the harmonic frequency of the adjusted clock signal CLKa (frequency Fclk) that is transmitted by the clock transmitting unit 30 is set to (k×Fosc/n) and the harmonic frequency of the adjustment clock signal CLKa is excluded from a band of the received frequency Frx. Accordingly, an influence on the received frequency Frx by the harmonic of the clock signal CLK is decreased, and the degradation of the reception sensitivity is suppressed.

On the other hand, when the harmonic frequency (k×Fosc) of the clock signal CLK does not overlap the received frequency Frx, the control unit 60 selects the input channel 0 within the selection circuit 22 according to the control signal CL1. Accordingly, the selection circuit 22 outputs the clock signal CLK (frequency Fosc), which is input into the input channel 0, to the clock transmitting unit 30. In this case, because the influence on the received frequency Frx by the harmonic of the clock signal CLK is not present, the degradation of the reception sensitivity does not occur.

Furthermore, if the adjustment clock signal CLKa is selected, the control unit 60 selects the frequency control code FCWc and outputs a result of the selection to the BBPLL 40. The BBPLL 40 converts the frequency Fclk of the adjustment clock signal CLKa into the frequency FPLL, based on the frequency control code FCWc.

On the other hand, if the clock signal CLK is selected, the control unit 60 selects the frequency control code FCW and outputs a result of the selection to the BBPLL 40. The BBPLL 40 converts the frequency Fosc of the clock signal CLK into the frequency FPLL, based on the frequency control code FCW.

Even though either the clock signal CLK or the adjustment clock signal CLKa is selected, the control unit 60 corrects a frequency control code in such a manner that the frequency FPLL of the clock signal CLKb that is output from the BBPLL 40 does not change. According to the present embodiment, because the frequency FPLL that is output from the BBPLL 40 does not change, other circuits that use the clock signal CLKb (frequency FPLL) are not disturbed.

Similarly, the local signal CLKr is output from the RFPLL 90 in the adjustment unit 70, the correction unit 100, and the clock transmitting unit 80 that are disposed between the reference oscillation circuit 10 and the RFPLL 90 in FIG. 1. Because these configurations are substantially the same as those of the adjustment unit 20, the correction unit 50, and the clock transmitting unit 30 that are described above, descriptions of the configurations are omitted.

Next, example configurations of the adjustment unit 20 and the correction unit 50 are described in detail.

FIG. 5 is a circuit diagram illustrating a configuration of the adjustment unit 20 in FIG. 3.

The adjustment unit 20 includes a delay circuit 23, a selection circuit 24, and a counter 25. The delay circuit 23 includes multiple amplifiers 23-1, 23-2, and so forth up to 23-256 that are connected in series to one another to form a ring oscillator, such as an injection-locked oscillator. The selection circuit 24, for example, has input channels 1, 2, and so forth up to 256. The input channels 1 to 256 of the selection circuit 24 are connected to input terminals of the amplifiers within the delay circuit 23, respectively. The counter 25 outputs a selection signal by which the input channel within the selection circuit 24 is output, according to the control signal CL1 from the control unit 60. The selection circuit 24 selects any one of the input channels according to the selection signal from the counter 25, and outputs a signal that is input into the selected channel, as the adjustment clock signal CLKa (frequency Fclk).

The clock signal CLK that is output from the reference oscillation circuit 10 is input into the delay circuit 23 and the counter 25. The counter 25 counts clocks of the clock signal CLK being input, and outputs the selection signal by which any one of the input channels 1 to 256 is selected in a manner that conforms to the number of counted clocks, according to the control signal CL1 from the control unit 60.

The selection circuit 24 selects the input channel according to the selection signal. For example, the selection circuit 24 selects the input channel 1 in the first place, and outputs the adjustment clock signal (frequency Fclk) from the input channel 1. The input channel 2 is selected in the second place, and the adjustment clock signal CLKa is output from the input channel 2. The input channel 3 is selected in the third place, and the adjustment clock signal CLKa is output from the input channel 3. The input channel is selected one-by-one in this manner, and thus the frequency Fclk of the adjustment clock signal CLKa is adjusted to Fosc*256/(1+256).

FIG. 6 is a circuit diagram illustrating a configuration of the correction unit 50 in FIG. 3.

The correction unit 50 includes a shift circuit 51A, an adder 51B, and the selection circuit 52. The frequency control code FCW is input into each of the shift circuit 51A, the adder 51B, and one of the input channels, channel 0, of the selection circuit 52. The frequency control code FCW that is input into the shift circuit 51A is shifted by 8 bits by the shift circuit 51A and is input into the adder 51B. The adder 51B adds the frequency control code that is shifted by the shift circuit 51A, and the directly-input frequency control code, and outputs the corrected frequency control code FCWc to the other input channel, channel 1, of the selection circuit 52.

The selection circuit 52 selects either of the input channels 0 and 1 according to the control signal CL2 from the control unit 60. For example, if the input channel 0 is selected, the selection circuit 52 outputs the frequency control code FCW. If the input channel 1 is selected, the selection circuit 52 outputs the corrected frequency control code FCWc.

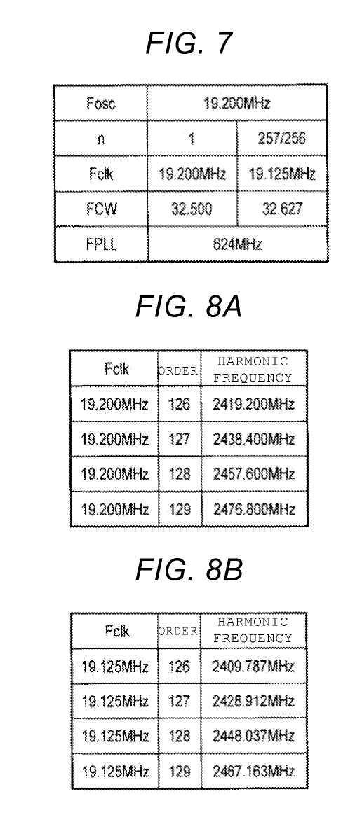

Next, an example of operation of the circuit illustrated in FIGS. 3, 5 and 6 according to the embodiment is described. FIG. 7 is a diagram illustrating an example in which frequencies of various clock signals are present, according to the embodiment.

When n is 1 and the frequency Fosc of the reference clock signal CLK is 19.200 MHz, that is, when the frequency Fosc is not adjusted, the frequency does not change, and the frequency Fclk becomes 19.200 MHz. At this point, if the frequency control code FCW is 32.500, the frequency FPLL of the clock signal CLKb that is output from the BBPLL 40 becomes 624 MHz.

When n is (257/256) and the frequency Fosc of the reference clock signal CLK is 19.200 MHz, if the frequency Fosc is multiplied by (1/n), that is, if the frequency Fosc is multiplied by (256/257), the frequency Fosc slightly decreases and the frequency Fclk becomes 19.125 MHz. At this point, if the frequency control code FCW is 32.500, the frequency FPLL of the clock signal CLKb that is output from the BBPLL 40 becomes 621.562 MHz, and thus deviates from a frequency of 624 MHz that is used in the downstream circuit.

So, the correction value (32.500*(257/256)=32.627) of the frequency control code FCW is obtained by multiplying the frequency control code FCW (32.500) by n. So, the frequency FPLL of the clock signal CLKb that is output from the BBPLL 40 is set to be 624 MHz by multiplying the frequency Fclk (19.125 MHz) by 32.627 (correction value).

As described above, if the harmonic frequency of the clock signal CLK (frequency Fosc) overlaps the received frequency Frx, the harmonic frequency of the adjustment clock signal CLKa (frequency Fclk) that is transmitted by the clock transmitting unit 30 may be prevented from overlapping the received frequency Frx, by shifting the frequency Fosc (19.200 MHz) to the frequency Fclk (19.125 MHz). Accordingly, the 1 degradation of the reception sensitivity in the receiving unit 120 is suppressed.

Moreover, when the frequency Fosc is shifted to the frequency Fclk (19.125 MHz), because a deviation in the frequency FPLL of the clock signal CLKb that is output from the BBPLL 40 is also prevented from occurring, the frequency control code FCW that is used in the BBPLL 40 is corrected. The correction of the frequency control code FCW is set according to the adjustment value that is used when the frequency Fosc is shifted. Accordingly, because the frequency FPLL of the clock signal CLKb that is output from the BBPLL 40 is a constant 624 MHz, the influence on the downstream circuit that uses the clock signal CLKb (frequency FPLL) is prevented.

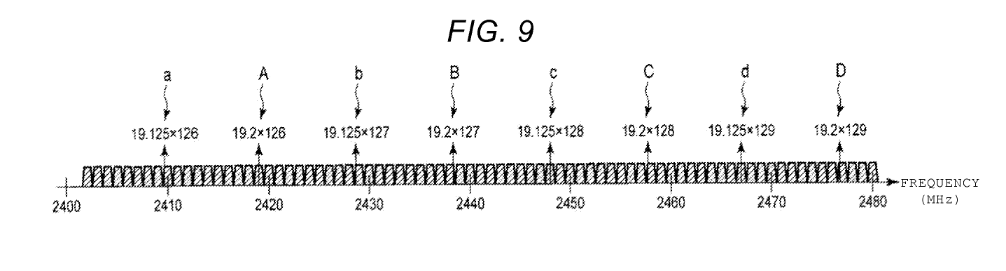

FIGS. 8A and 8B are diagrams illustrating examples of the frequency Fclk of the adjustment clock signal according to the embodiment. FIG. 8A illustrates the frequency Fclk and the harmonic frequency of the frequency Fclk that is available when the clock signal CLK (frequency Fosc) is not adjusted. FIG. 8B is a diagram illustrating the frequency Fclk and the harmonic frequency of the frequency Fclk that is available when the frequency Fosc is adjusted. FIG. 9 illustrates the harmonic frequency of the frequency Fclk that is available if the frequency Fosc is not adjusted and if the frequency Fosc is adjusted, in a band of the receive frequency band for Bluetooth.

For example, as illustrated in FIG. 8A, when the frequency Fclk is 19.200 MHz, and orders of harmonics are 126, 127, 128, and 129, respectively, the harmonics are set to 2419.200 MHz (A in FIG. 9), 2438.400 MHz (B in FIG. 9), 2457.600 MHz (C in FIG. 9), and 2476.800 MHz (D in FIG. 9), respectively.

In the band of the receive frequency for Bluetooth, for example, if signals at frequencies of 2419 MHz, 2438 MHz, 2458 MHz, and 2479 MHz are received, the harmonic frequencies of the frequencies Fclk illustrated in FIG. 8A overlap the receive frequencies. For this reason, the control unit 60 causes the adjustment unit 20 to adjust the frequency Fosc of the clock signal CLK, and sets the frequency Fclk of the clock signal CLKa to 19.125 MHz. Accordingly, when orders of harmonics of the frequency Fclk (19.125 MHz) are 126, 127, 128, and 129, respectively, the harmonic frequencies are set to 2409.787 MHz (a of FIG. 9), 2428.912 MHz(b of FIG. 9), 2448.037 MHz (c of FIG. 9) and 2467.163 MHz (d of FIG. 9).

According to the embodiment, in this manner, the clock signal CLK at the frequency Fosc is adjusted to the adjustment clock signal at the frequency Fclk, thus the harmonic frequency of the adjustment clock signal (frequency Fclk) that is transmitted by the clock transmitting unit 30 does not overlap the receive frequency. Accordingly, the degradation of the reception sensitivity in the receiving unit is suppressed.

According to the embodiment, as described above, a radio communication apparatus is provided to suppress the degradation of the reception sensitivity due to the harmonic occurring from the transmission path for the clock signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A radio communication apparatus comprising:
an adjustment unit configured to adjust a first frequency of a first clock signal to generate a second clock signal having a second frequency, based on an adjustment value;
a transmitting unit configured to transmit the second clock signal;
a correction unit configured to correct the second frequency of the second clock signal that is transmitted by the transmitting unit, which results in a third frequency, using a correction value; and
a control unit configured to set the adjustment value according to a receive frequency of a receive signal, obtain the correction value from the adjustment value, and set the correction value.

2. The apparatus according to claim 1, wherein the control unit is configured to set the adjustment value so that a harmonic frequency of the second frequency is excluded from the receive frequency.

3. The apparatus according to claim 1,
wherein the adjustment value is a small numerical value that is about 1, and
wherein the adjustment unit is configured to generate the second frequency by multiplying the first frequency by the small numerical value that is about 1.

4. The apparatus according to claim 1,
wherein the adjustment value is 1/n; and
wherein the adjustment unit includes:
a frequency conversion circuit configured to generate the second frequency by multiplying the first frequency by the 1/n, and
a selection circuit configured to select any one of the first frequency and the second frequency, and wherein the 1/n is a small numerical value that is about 1.

5. The apparatus according to claim 1, further comprising a phase locked loop (PLL) circuit configured to convert the second frequency into the third frequency.

6. The apparatus according to claim 1,
wherein the correction value is the n, and
wherein the correction unit is configured to generate a second control code by multiplying a first control code by the n, and convert the second frequency into the third frequency based on the second control code.

7. The apparatus according to claim 1,
wherein the correction unit includes:
a correction circuit configured to correct a first control code based on the correction value, and generate a second control code,
a selection circuit configured to select any one of the first control code and the second control code, and
a phase locked loop (PLL) circuit configured to convert the second frequency into the third frequency based on any one of the first control code and the second control code that is selected by the selection circuit.

8. The apparatus according to claim 5, wherein the PLL circuit is a base band phase locked loop circuit.

9. The apparatus according to claim 5, wherein the PLL circuit is a radio frequency phase locked loop circuit.

10. A clock correcting circuit comprising:
an adjustment unit configured to receive a clock generated from a reference oscillation circuit and adjust the frequency of the clock in response to an instruction from a control unit, the adjustment unit generating a second clock running at the adjusted frequency;
a correction unit configured to provide a corrected frequency control code for correcting the frequency of the second clock in response to the instruction from the control circuit; and
a phase-locked loop configured to receive the second clock running at the adjusted frequency and the corrected frequency control code, the phase locked loop generating a third clock based on the corrected frequency control code such that the third clock is substantially equal to the clock from the reference oscillation circuit.

11. The clock correcting circuit according to claim 10, wherein the adjustment unit includes:
a ring oscillator configured to receive the clock from the reference oscillation circuit and generate a plurality of phases at the frequency of the reference oscillation circuit;
a counter configured to receive the clock from the reference oscillation circuit and a control signal from the control unit and generate a digital count of the clock in response to the control signal; and
a selection circuit configured to receive the digital count and the plurality of phases of the ring oscillator and generate the second clock running at the adjusted frequency in response to the digital count.

12. The clock correcting circuit according to claim 11, wherein the ring oscillator is an injection locked oscillator.

13. The clock correcting circuit according to claim 10, wherein the correction circuit includes:
a shift circuit configured to receive a frequency control code and generate a digital output in response to the frequency control code, the digital output being a shifted version of the frequency control code;
an adder configured to receive the frequency control code and the digital output from the shift circuit and generate the sum of the frequency control code and the digital output from the shift circuit, the sum being a corrected frequency control code; and
a selection circuit configured to receive the frequency control code, the corrected frequency control code from the adder, and a control input from the control unit, the selection circuit selecting one of the frequency control code and the sum in response to the control input.

14. The clock correcting circuit according to claim 10, wherein the PLL is a radio frequency PLL.

15. The clock correcting circuit according to claim 10, wherein the PLL is a baseband PLL.

16. A method for correcting a frequency of a clock circuit, the method comprising:
determining that a first clock running at a reference frequency needs an adjustment to avoid interference with another signal;
generating a control instruction in response to said determining step;
adjusting the first clock to generate a second clock in response to the control instruction, the second clock having a frequency that avoids interference with the other signal;
generating a corrected frequency control code for correcting the second clock in response to the control instruction; and
providing the second clock and the corrected frequency control code to a phase-locked loop to generate a third clock, wherein the third clock has a frequency that is substantially equal to the first clock.

17. The method according to claim 16, wherein the step of adjusting the first clock to generate the second clock is performed by:
generating a plurality of phase-shifted clock signals, each clock signal running at the reference frequency but having a different phase; and
selecting sequentially each of the plurality of phase-shifted clock signals to generate the second clock.

18. The method according to claim 17, wherein the plurality of phase-shifted clock signals is 256 and the second clock is adjusted by 256/257 times the frequency of the first clock.

19. The method according to claim 16, wherein the step of generating a frequency control code is performed by:
shifting the frequency control code to generate a shifted frequency control code; and
adding the shifted frequency control code to the frequency control code to generate a corrected frequency control code.

20. The method according to claim 19, wherein the corrected frequency control code corrects the second clock by a factor of 257/256.
